(19) United States
(12) Patent Application Publication
(10) Pub. No.: US 2010/0115583 A1
(43) Pub. Date: May 6, 2010

(54) METHOD FOR FAULT-TOLERANT USER INFORMATION AUTHENTICATION

(75) Inventors: Wayne Michael Delia, Poughkeepsie, NY (US); Edward Emile Kelley, Wappingers Falls, NY (US); Franco Motika, Hopewell Junction, NY (US)

Correspondence Address: Law Offices of Ira D. Blecker, P.C., 206 Kingwood Park, Poughkeepsie, NY, 12601, US

(73) Assignee: INTERNATIONAL BUSINESS MACHINES CORPORATION, Armonk, NY (US)

(21) Appl. No.: 12/263,540

(22) Filed: Nov. 3, 2008

(51) Int. Cl. H04L 9/32

(52) U.S. Cl. 726/2

(57) ABSTRACT

A method for user information authentication which includes setting user information for a user account, such user information being the set user information; inputting user information by a user for the user account into a device, such user information being the input user information; evaluating the input user information for correspondence with the set user information according to fault-tolerant user information rules, wherein such rules evaluate the input user information for content and closeness to the set user information and noting if the input user information is a valid user information, a fault-tolerant user information, or an invalid user information; authorizing access to the user account if the input user information is a valid user information. In one embodiment of the invention, the method includes incrementing an invalid user information counter only if the user information is an invalid user information. In another embodiment of the invention, the method includes providing a message to the user if the user information is a fault-tolerant user information, the message being descriptive of the input user information's correspondence with the fault tolerant user information rules.

### BACKGROUND OF THE INVENTION

The present invention relates to user information authentication for use of an user account on a device and more particularly, relates to the use of user information for user information authentication which are close but not exactly the same as the set user information.

The use of security code-based access to secure information via user passwords and/or usernames (collectively referred to hereafter as “user information”) has increased dramatically with the increased use of data networks such as the Internet, local area networks, automated teller machines, voicemail and the like as well as stand alone computer workstations and laptops. The desire for on-demand access to protected information and services has resulted in a greater use of security code-based validation of the user's identity.

With increasing concern for privacy, identity protection, safeguarding confidential data, and preventing virus attacks from the Internet, authentication methods to gain access to workstations, networks and local area networks are becoming more and more strict Innovation in this area consists of methods to close exposure holes and generally make user information authentication tighter and stricter. The increased use of user information-based access has also served to complicate the user experience by reducing the ease in which a user may gain access to their requested information and services.

Further, these restrictive rules remain in place even when not particularly needed, such as the case of a stand-alone single-user computer workstation, or a small firewalled local area network owned by a family, where all (or most) users on the networked system are trusted. In stand-alone or small networked systems, high levels of security are not always necessary, but the choices are limited to no user information (0% secure) or operating-system controlled user information (100% secure).

When a required user information is incorrectly entered, no assistance is available. The cause of user information input error may vary depending on the individual and/or environment. Some of these errors may be the result of a keystroke error due to a misplaced finger, user confusion, or failure to recall their user information. Further, some errors may result from the reduction in keypad size for many mobile devices such as mobile phones, PDAs, and notebook computers. These issues may be exacerbated when the person entering the user information is physically afflicted with reduced vision, tremors, lost or malformed appendages, or other disability. Further still, factors such as the physical size of a person's finger or hand may correspond to the frequency or type of input errors that may occur. Each of the above issues may be further magnified as the technology using population continues to age and the use of user information protection of data networks increases. And yet, there is no feedback provided to the user as to the user information incorrectly entered.

There are instances in different operating system platforms where it is necessary to assign user information. In certain environments (i.e. AIX, Linux, or UNIX), each personal or system administrator account requires user information. In Windows environment, if a workstation account needs to connect to a DB2 database, that account may need user information to be authorized for certain levels of database access.

When using an environment which does not especially require high levels of authentication security, but in which user information is required, incorrectly entered user information may count towards a defined threshold of invalid access attempts as registered by the invalid user information counter. Excessive invalid access attempts can lead to suspension of the account. Often, the user information incorrectly entered is the result of a typographic error of one or two characters. A similar error is when all but the last character of the user information was typed, and the Enter key was prematurely hit. Yet another authentication error occurs when a previously used but recently changed user information was entered out of force of habit. Each of these three situations would count as an invalid user information attempt, leading towards possible account suspension.

No current user information authentication protocol provides a method to distinguish between wrong user information and sufficiently close “near misses” while providing feedback to the user or adjusting the invalid user information counter.

Various solution have been proposed for user information access.

Moy U.S. Pat. No. 5,425,102, the disclosure of which is incorporated by reference herein, discloses a computer security apparatus which presents a prerecorded hint if the user cannot remember the user information. If the initial user information hint does not cause the user to recall the user information, more specific user information hints can be provided to ultimately induce the user to recall the user information.

Rissanen U.S. Pat. No. 5,430,827, the disclosure of which is incorporated by reference herein, discloses a user information verification system in which a user speaks an assigned user information which is compared to the user's speech models to determine a measure of similarity. The validity of the user information is determined based upon this measure of similarity.

Hiles U.S. Pat. No. 6,026,491, the disclosure of which is incorporated by reference herein, discloses a user information-phrasing security mechanism in which the system challenges the user with a personalized challenge phrase and the user responds with a response phrase. If the user response is a substantial match for the expected response phrase, the user is granted access to the system.

Dulude et al. U.S. Pat. No. 6,310,966, the disclosure of which is incorporated by reference herein, discloses an authentication method using biometrics.

Juels et al. U.S. Patent Application Publication 2002/0120592, the disclosure of which is incorporated by reference herein, discloses an authentication system in which a user can input predetermined information in no particular order and the system uses fuzzy logic to determine if there is sufficient overlap to authenticate the user.

Andri U.S. Patent Application Publication 2008/0066167, the disclosure of which is incorporated by reference herein, discloses a user information authentication method in which a password or username entered by the user includes one or more errors. If the number of errors is less than the error allowance, the user is granted access to the system. If the number of errors exceeds the error allowance, then the user is denied access.

### BRIEF SUMMARY OF THE INVENTION

The various advantages and purposes of the present invention as described above and hereafter are achieved by providing, according to a first aspect of the invention, a method for user information authentication comprising the steps of:

setting user information for a user account, such user information being the set user information;

inputting user information by a user for the user account into a device, such user information being the input user information;

evaluating the input user information for correspondence with the set user information according to fault-tolerant user information rules, wherein such rules evaluate the input user information for content and closeness to the set user information and noting if the input user information is a valid user information, a fault-tolerant user information, or an invalid user information;

authorizing access to the user account if the input user information is a valid user information; and

incrementing an invalid user information counter only if the user information is an invalid user information.

According to a second aspect of the invention, there is discloses a method for user information authentication comprising the steps of:

setting a user information for a user account, such user information being the set user information;

inputting a user information by a user for the user account into a device, such user information being the input user information;

evaluating the input user information for correspondence with the set user information according to fault-tolerant user information rules, wherein such rules evaluate the input user information for content and closeness to the set user information and noting if the input user information is a valid user information, a fault-tolerant user information, or an invalid user information;

authorizing access to the user account if the input user information is a valid user information; and

providing a message to the user if the user information is a fault-tolerant user information, the message being descriptive of the input user information's correspondence with the fault tolerant user information rules.

According to a third aspect of the invention, there is disclosed a method for a user information authentication service provided to a user comprising the steps of:

setting user information for a user account, such user information being the set user information;

receiving user information from a user for the user account, such user information being the input user information;

evaluating the input user information for correspondence with the set user information according to fault-tolerant user information rules, wherein such rules evaluate the input user information for content and closeness to the set user information and noting if the input user information is a valid user information, a fault-tolerant user information, or an invalid user information;

authorizing access to the user account if the input user information is a valid user information; and

incrementing an invalid user information counter only if the user information is an invalid user information.

According to a fourth aspect of the invention, there is disclosed a method for a user information authentication service provided to a user comprising the steps of:

setting a user information for a user account, such user information being the set user information;

receiving a user information by a user for the user account, such user information being the input user information;

evaluating the input user information for correspondence with the set user information according to fault-tolerant user information rules, wherein such rules evaluate the input user information for content and closeness to the set user information and noting if the input user information is a valid user information, a fault-tolerant user information, or an invalid user information;

authorizing access to the user account if the input user information is a valid user information; and

providing a message to the user if the user information is a fault-tolerant user information, the message being descriptive of the input user information's correspondence with the fault tolerant user information rules.

### BRIEF DESCRIPTION OF THE DRAWINGS

The features of the invention believed to be novel and the elements characteristic of the invention are set forth with particularity in the appended claims. The Figures are for illustration purposes only and are not drawn to scale. The invention itself, however, both as to organization and method of operation, may best be understood by reference to the detailed description which follows taken in conjunction with the accompanying drawings in which:

FIG. 1 is a block diagram that illustrates one exemplary hardware environment of the present invention.

FIG. 2 is a flow chart that illustrates the overall process flow of the present invention.

FIG. 3 illustrates the method steps of a first embodiment of the present invention.

FIG. 4 illustrates the method steps of a second embodiment of the present invention.

### DETAILED DESCRIPTION OF THE INVENTION

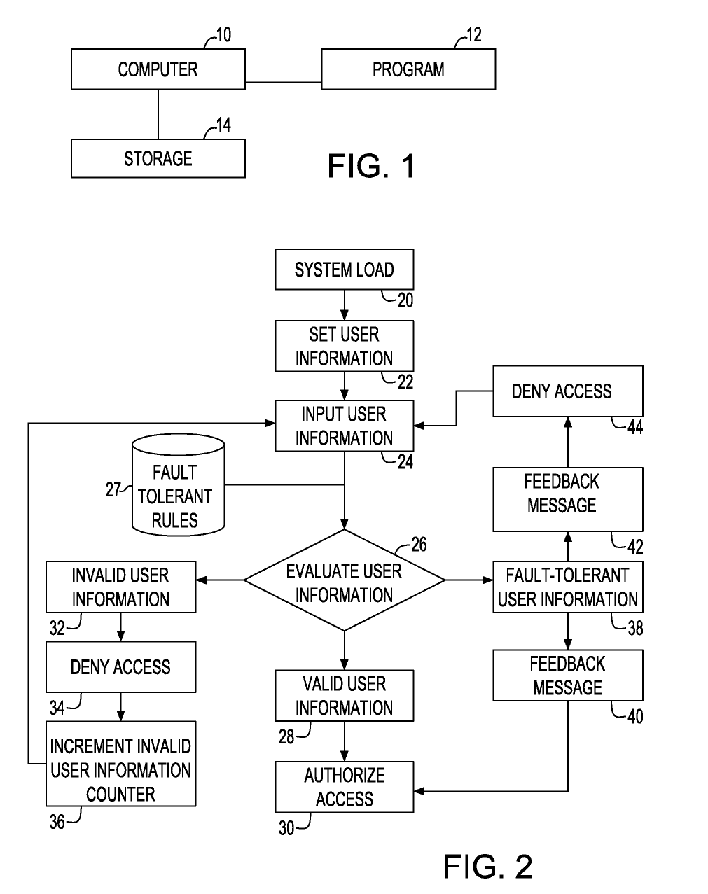

The program environment in which a present embodiment of the invention is executed illustratively incorporates a general-purpose computer or a special purpose device such as a hand-held computer. FIG. 1 is a block diagram that illustrates one exemplary hardware environment of the present invention. The present invention is typically implemented using a computer 10 comprised of microprocessor means, random access memory (RAM), read-only memory (ROM) and other components. The computer may be a personal computer, mainframe computer or other computing device. Resident in the computer 10, or peripheral to it, will be a storage device 14 of some type such as a hard disk drive, floppy disk drive, CD-ROM drive, tape drive or other storage device.

Generally speaking, the software implementation of the present invention, program 12 in FIG. 1, is tangibly embodied in a computer-readable medium such as one of the storage devices 14 mentioned above. The program 12 comprises instructions which, when read and executed by the microprocessor of the computer 10 causes the computer 10 to perform the steps necessary to execute the steps or elements of the present invention.

It should also be understood that the techniques of the present invention may be implemented using a variety of technologies. For example, the methods described herein may be implemented in software executing on a computer system, or implemented in hardware utilizing either a combination of microprocessors or other specially designed application specific integrated circuits, programmable logic devices, or various combinations thereof. In particular, the methods described herein may be implemented by a series of computer-executable instructions residing on a suitable computer-readable medium. Suitable computer-readable media may include volatile (e.g., RAM) and/or non-volatile (e.g., ROM, disk) memory, carrier waves and transmission media (e.g., copper wire, coaxial cable, fiber optic media). Exemplary carrier waves may take the form of electrical, electromagnetic or optical signals conveying digital data streams along a local network, a publicly accessible network such as the Internet or some other communication link.

The present invention is directed to an operating system authentication protocol which can be configured by a system administrator in which the authentication enforcement levels can be adjusted downwardly for an environment which may not require a high level of security.

In the following discussion, reference will be made to “user information”. It should be understood that user information can be a user's account information (such as account name or account number) and/or a user's account password. Both of the user's account information and account password are subject to the same problem of remembering the exact sequence of characters and so both are considered to be within the scope of the present invention.

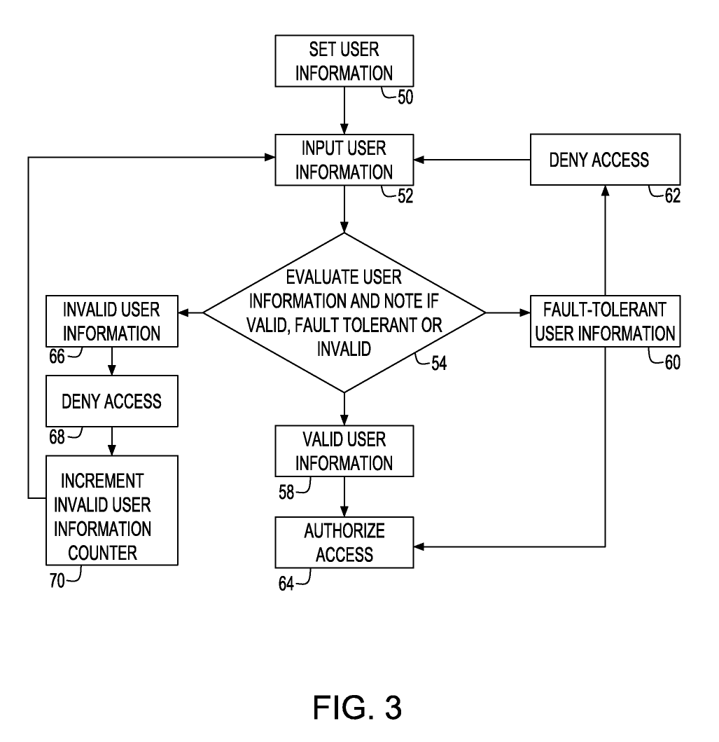

Turning now to FIGS. 2 and 3 simultaneously, one preferred embodiment of the present invention will be discussed. Initially, the system rules are loaded at system load, block 20 in FIG. 2. In a first step of the method according to the present invention as shown at block 22 in FIG. 2 and block 50 in FIG. 3, user information will be set in a device or system (hereafter just system) by a user or a system administrator. For example, a user of a laptop or workstation would very likely set his or her own user information. In a situation like a local area network, the user information could be set by a system administrator who could provide user account and beginning password information to a user. Thereafter, the user would change the beginning password to a password that the user would be more comfortable using. This latter password is the password that is set according to the present invention and which must be remembered by the user.

The present invention is applicable to any system which requires the inputting of user information and could include, by way of illustration and not limitation, a laptop, computer workstation, local area network, wide area network, remote access to an account, authentication service, automated teller machine, personal digital assistant and the like.

In the next step of the method according to the present invention as shown at block 24 in FIG. 2 and block 52 in FIG. 3, the user inputs the user information which can be the account name, the account password, both pieces of information or other similar types of information.

Next, as shown at block 26 in FIG. 2 and block 54 in FIG. 3, the user information would be evaluated by the system. The evaluation includes comparing the input user information to the set user information and checking for 1 to 1 correspondence of the individual characters. For any variance between the input user information and the set user information, whether to accept the variance in the user information is evaluated according to fault tolerant rules which have been previously loaded in the system by the user or a system administrator and stored at storage unit 27 shown in FIG. 2.

The fault tolerant rules evaluate the input user information for content and closeness to the set user information. Some examples of this evaluation, for purposes of illustration and not limitation, include:
input user information differs from the set user information by one character (for example, the set user information is “asdf' but the user inputs “asdr”);
input user information is terminated before entering the final character (for example, the set user information is “asdf' but the user inputs “asd”);
an input character is similar to a letter character (for example, the set user information is “uiop” but the user inputs “ulop”);
an input character is similar to a number character(for example, the set user information is “hjk7” and the user inputs “hjkt”);
input user information differs from the set user information by one or more characters which are typographical errors offset by a single key (for example, the set user information is “hjkl” and the user input “yjko”); and
user inputs user information which has been superseded by new user information (for example, the set user information is “uiop” and the user inputs “hjkl” which is the previously used user information).

Any input user information that meets the fault tolerant rules is denoted as “fault tolerant user information” while any input user information which exactly matches the set user information is denoted as “valid user information”. Lastly, any input information that is not valid user information and does not meet the fault tolerant rules is denoted as “invalid user information”.

It should be understood that the foregoing examples are only examples of situations which could meet the fault tolerant rules. The fault tolerant rules are set by the user or system administrator and can be varied up (tougher) or down (easier) to meet the particular situation.

As part of the evaluation step, the input user information is noted as falling into one of the above categories, i.e., valid user information, fault tolerant user information or invalid user information. The system may simply evaluate the user input information and store the categorization of the input user information in a memory register or may actually display a message to the user such as “your password is invalid” or “your password is valid”.

If after evaluation of the input user information, it is determined that the input user information is valid (i.e., an exact match with the set user information), then the system indicates that the input user information is valid user information as shown in block 28 of FIG. 2 and block 58 of FIG. 3. The subsequent step is to authorize access as indicated by blocks 30 of FIGS. 2 and 64 of FIG. 3.

Alternatively, after evaluation of the input user information, it is determined that the input user information complies with the fault tolerant rules, then the system indicates that the input user information is fault tolerant user information as shown in block 38 in FIG. 2 and block 60 in FIG. 3. Depending on the application of the fault tolerant rules, the system would either deny access, as shown in blocks 44 of FIGS. 2 and 62 of FIG. 3, or authorize access, as shown in blocks 30 of FIGS. 2 and 64 of FIG. 3. If access is denied, then the user would be required to input the user information again as indicated by blocks 24 of FIGS. 2 and 52 of FIG. 3.

The evaluation step previously discussed may further find that the input user information is invalid as indicated in blocks 32 of FIGS. 2 and 66 of FIG. 3. In this case, the user is denied access to the system, indicated by blocks 34 of FIGS. 2 and 68 of FIG. 3. The user would then be required to give it another try and input their user information again as indicated by blocks 24 of FIGS. 2 and 52 of FIG. 3.

Many systems which require authentication have counters which count the number of times that user information is entered incorrectly. After a certain number of incorrect inputs of user information, usually 3, the user is locked out and the user information needs to be reset. The resetting of user information is inconvenient and is to be avoided if possible.

According to the present invention, there is a counter which is incremented each time invalid user information is inputted, as indicated by blocks 36 of FIGS. 2 and 70 of FIG. 3. However, it should be noted that the counter is incremented only when invalid user information is inputted. When fault tolerant user information is inputted, the counter is not incremented. Thus, as long as the user information that is inputted falls within the application of the fault tolerant rules, the counter is not incremented in even those circumstances when the user is denied access and the user may try repeatedly without incurring the penalty of being locked out.

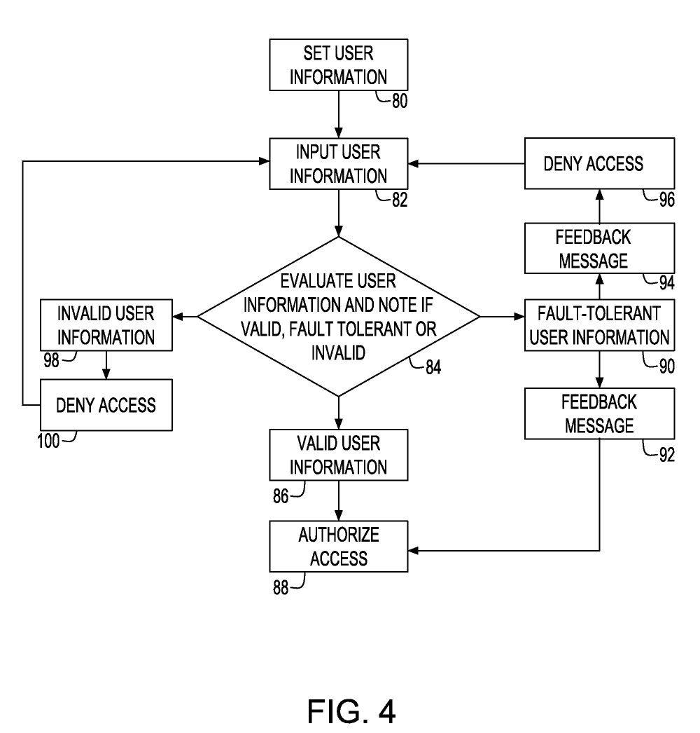

Turning now to FIGS. 2 and 4 simultaneously, a second preferred embodiment of the present invention will be discussed. Initially, the system rules are loaded at system load, block 20 in FIG. 2. In a first step of the method according to the present invention as shown at block 22 in FIG. 2 and block 80 in FIG. 4, user information will be set in a system (as defined above) by a user or a system administrator. For example, a user of a laptop or workstation would very likely set his or her own user information. In a situation like a local area network, the user information could be set by a system administrator who could provide user account and beginning password information to a user. Thereafter, the user would change the beginning password to a password that the user would be more comfortable using. This latter password is the password that is set according to the present invention and which must be remembered by the user.

In the next step of the method according to the present invention as shown at block 24 in FIG. 2 and block 82 in FIG. 4, the user inputs the user information which can be the account name, the account password, both pieces of information, or other similar types of information.

Next, as shown at block 26 in FIG. 2 and block 84 in FIG. 3, the user information would be evaluated by the system. The evaluation includes comparing the input user information to the set user information and checking for 1 to 1 correspondence of the individual characters. For any variance between the input user information and the set user information, whether to accept the variance in the user information is evaluated according to fault tolerant rules which have been previously loaded in the system by the user or a system administrator and stored at storage unit 27 shown in FIG. 2.

The fault tolerant rules evaluate the input user information for content and closeness to the set user information as discussed above.

Any input user information that meets the fault tolerant rules is denoted as “fault tolerant user information” while any input user information which exactly matches the set user information is denoted as “valid user information”. Lastly, any input information that is not valid user information and does not meet the fault tolerant rules is denoted as “invalid user information”.

It should be understood that the foregoing examples are only examples of situations which could meet the fault tolerant rules. The fault tolerant rules are set by the user or system administrator and can be varied up (tougher) or down (easier) to meet the particular situation.

As part of the evaluation step, the input user information is noted as falling into one of the above categories, i.e., valid user information, fault tolerant user information or invalid user information. The system may simply evaluate the user input information and store the categorization of the input user information in a memory register or may actually display a message to the user such as “your password is invalid” or “your password is valid”.

If after evaluation of the input user information, it is determined that the input user information is valid, the system indicates that the input user information is valid as indicated in block 28 of FIG. 2 and block 86 of FIG. 4. The subsequent step is to authorize access as indicated by blocks 30 of FIGS. 2 and 88 of FIG. 4.

Alternatively, after evaluation of the input user information, it is determined that the input user information complies with the fault tolerant rules, then the next step would be block 38 in FIG. 2 and block 90 in FIG. 4. Depending on the application of the fault tolerant rules, the system would either deny access, as shown in blocks 44 of FIGS. 2 and 96 of FIG. 4, or authorize access, as shown in blocks 30 of FIGS. 2 and 88 of FIG. 4. If access is denied, then the user would be required to input the user information again as indicated by blocks 24 of FIGS. 2 and 82 of FIG. 4.

The evaluation step previously discussed may further find that the input user information is invalid as indicated in blocks 32 of FIGS. 2 and 98 of FIG. 4. In this case, the user is denied access to the system, indicated by blocks 34 of FIGS. 2 and 100 of FIG. 4. The user would then be required to give it another try and input their user information again as indicated by blocks 24 of FIGS. 2 and 82 of FIG. 4.

An aspect of the second embodiment of the present invention is that the system may provide a contextual feedback message in response to any inputted fault tolerant user information. Instead of just providing a simple “Your password is invalid”, the system could provide, for example, a more meaningful “You used your previous password”. The context of the message would change depending on whether the fault tolerant rules are to authorize or deny access.

Some of the enumerated circumstances discussed above that could comprise fault tolerant user information are:
input user information differs from the set user information by one character (for example, the set user information is “asdf' but the user inputs “asdr”);
input user information is terminated before entering the final character (for example, the set user information is “asdf' but the user inputs “asd”);
an input character is similar to a letter character (for example, the set user information is “uiop” but the user inputs “ulop”);
an input character is similar to a number character(for example, the set user information is “hjk7” and the user inputs “hjkt”);
input user information differs from the set user information by one or more characters which are typographical errors offset by a single key (for example, the set user information is “hjkl” and the user input “yjko”); and
user inputs user information which has been superseded by new user information (for example, the set user information is “uiop” and the user inputs “hjkl” which is the previously used user information).

Again, this list is not exclusive.

In regards to the first erroneous input above, a contextual feedback message in denying access could be “Your password is off by one character”. Alternatively, the contextual feedback message in authorizing access could be “Please keep in mind that your password is ‘asdf”.

In regards to the second erroneous input above, a contextual feedback in denying access could be “You forgot to type one character of your password”. The contextual feedback message in authorizing access could be “You typed ‘asd’ but your password is ‘asdf”.

In regards to the third and fourth erroneous inputs above, a contextual feedback message in denying access could be “Please check to see if you inadvertently typed a number in place of a letter.” The contextual feedback message in authorizing access could be “You typed ‘uiop’ but your password is ‘ulop’”.

In regards to the fifth erroneous input above, a contextual message in denying access could be “You most likely made a typographical error in typing your password.” A contextual message in authorizing access could be “You entered ‘yiko’ but your password is ‘hjkl’”.

In regards to the sixth erroneous input above, a contextual message in denying access could be “You have entered a previous password.” A contextual message in authorizing access could be “You entered your previous password which you changed last mm/dd/yy.”

Referring back to FIGS. 2 and 4, the process flows and method steps will be discussed with respect to the contextual feedback message aspect of the present invention. In blocks 38 of FIGS. 2 and 90 of FIG. 4, it has been indicated after the evaluating step that the inputted user information is fault-tolerant user information. If the parameters of the fault tolerant rules are to deny access, then a contextual feedback message is displayed to the user as indicated in blocks 42 of FIGS. 2 and 94 of FIG. 4. It should be noted that the timing of the contextual feedback message with respect to denying access is not important. That is, there will probably also be a message displayed when the user is denied access to the system. The contextual feedback message could be displayed at the same time or before or after the denied access message is displayed.

If the parameters of the fault tolerant rules are to authorize access, then a contextual feedback message is displayed to the user as indicated in blocks 40 of FIGS. 2 and 92 of FIG. 4. Again, the timing of the display of the contextual feedback message with respect to the authorizing access is not important as the contextual feedback message can be displayed at the same time or before or after access is authorized.

It will be apparent to those skilled in the art having regard to this disclosure that other modifications of this invention beyond those embodiments specifically described here may be made without departing from the spirit of the invention. Accordingly, such modifications are considered within the scope of the invention as limited solely by the appended claims.

1. A method for user information authentication comprising the steps of:
setting user information for a user account, such user information being the set user information;
inputting user information by a user for the user account into a device, such user information being the input user information;
evaluating the input user information for correspondence with the set user information according to fault-tolerant user information rules, wherein such rules evaluate the input user information for content and closeness to the set user information and noting if the input user information is a valid user information, a fault-tolerant user information, or an invalid user information;
authorizing access to the user account if the input user information is a valid user information; and
incrementing an invalid user information counter only if the user information is an invalid user information.

2. The method of claim 1 wherein the valid user information means that the input user information has exact correspondence with the set user information, the fault-tolerant user information means that the input user information deviates from the set user information by at least one character but less than a predetermined number of characters and the invalid user information means that the input user information deviates from the set user information by more than the predetermined number of characters.

3. The method of claim 1 further comprising authorizing access to the user account if the user information is a fault-tolerant user information.

4. The method of claim 1 further comprising denying access to the user account if the user information is a fault-tolerant user information.

5. The method of claim 1 further comprising providing a message to the user if the user information is a fault-tolerant user information, the message being descriptive of the input user information's correspondence with the fault tolerant user information rules.

6. The method of claim 5 further comprising authorizing access to the user account if the user information is a fault-tolerant user information.

7. The method of claim 5 further comprising denying access to the user account if the user information is a fault-tolerant user information.

8. The method of claim 1 wherein the user information is a password.

9. The method of claim 1 wherein the user information is a user's account information.

10. A method for user information authentication comprising the steps of:
setting a user information for a user account, such user information being the set user information;
inputting a user information by a user for the user account into a device, such user information being the input user information;
evaluating the input user information for correspondence with the set user information according to fault-tolerant user information rules, wherein such rules evaluate the input user information for content and closeness to the set user information and noting if the input user information is a valid user information, a fault-tolerant user information, or an invalid user information;
authorizing access to the user account if the input user information is a valid user information; and
providing a message to the user if the user information is a fault-tolerant user information, the message being descriptive of the input user information's correspondence with the fault tolerant user information rules.

11. The method of claim 10 wherein the valid user information means that the input user information has exact correspondence with the set user information, the fault-tolerant user information means that the input user information deviates from the set user information by at least one character but less than a predetermined number of characters and the invalid user information means that the input user information deviates from the set user information by more than the predetermined number of characters.

12. The method of claim 10 further comprising authorizing access to the user account if the user information is a fault-tolerant user information.

13. The method of claim 10 further comprising denying access to the user account if the user information is a fault-tolerant user information.

14. The method of claim 10 further comprising incrementing an invalid user information counter only if the user information is an invalid user information.

15. The method of claim 14 further comprising authorizing access to the user account if the user information is a fault-tolerant user information.

16. The method of claim 14 further comprising denying access to the user account if the user information is a fault-tolerant user information.

17. The method of claim 10 wherein the user information is a password.

18. The method of claim 10 wherein the user information is a user's account information.

19. A method for a user information authentication service provided to a user comprising the steps of:
setting user information for a user account, such user information being the set user information;
receiving user information from a user for the user account, such user information being the input user information;
evaluating the input user information for correspondence with the set user information according to fault-tolerant user information rules, wherein such rules evaluate the input user information for content and closeness to the set user information and noting if the input user information is a valid user information, a fault-tolerant user information, or an invalid user information;
authorizing access to the user account if the input user information is a valid user information; and
incrementing an invalid user information counter only if the user information is an invalid user information.

20. A method for a user information authentication service provided to a user comprising the steps of:
setting a user information for a user account, such user information being the set user information;
receiving a user information by a user for the user account, such user information being the input user information;
evaluating the input user information for correspondence with the set user information according to fault-tolerant user information rules, wherein such rules evaluate the input user information for content and closeness to the set user information and noting if the input user information is a valid user information, a fault-tolerant user information, or an invalid user information;
authorizing access to the user account if the input user information is a valid user information; and
providing a message to the user if the user information is a fault-tolerant user information, the message being descriptive of the input user information's correspondence with the fault tolerant user information rules.
